(19) United States
(12) Patent Application Publication
(10) Pub. No.: US 2009/0113892 A1
(43) Pub. Date: May 7, 2009

(54) Steam solar thermal collector generation system using solar power as a heating source

(76) Inventor: Chris Chen, Chino Hills, CA (US)

Correspondence Address: JACKSON WALKER, L.L.P., 112 E. PECAN, SUITE 2400, SAN ANTONIO, TX, 78205, US

(21) Appl. No.: 11/982,037

(22) Filed: Nov. 1, 2007

(51) Int. Cl. F03G 6/00

(52) U.S. Cl. 60/641.8

(57) ABSTRACT

A liquid solar thermal collector generation system has a liquid unit, a solar vaporizer, a turbine generator, a cooling and condensing unit, and a main control unit. The solar vaporizer heats a liquid from the liquid unit and converts the liquid to steam as a rotating power resource. As such result, the turbine generator is driven and then generates an electric power source. The steam passing through the turbine generator is re-converted to the liquid through the cooling and condensing unit, so the liquid unit from the cooling and condensing unit is recycled by the liquid unit. Therefore, the gaseous coolant solar thermal collector generation system utilizes the solar power to heat the coolant and further drive the steam generator, so the stream solar thermal collector generation system effectively utilizes the nature resource to generate the electric power source.

### BACKGROUND OF THE INVENTION

1. Field of the Invention

The present invention relates to a steam power generator, and more specifically to a steam solar thermal collector generation system using solar power as a heating source for generating steam.

2. Description of Related Art

Conventional energy generation uses non-renewable sources comprises nuclear and fossil fuels such as petroleum, coal, natural gas and the like. However, greater energy requirements and energy consumption have led to excessive extraction of fossil fuels leading to fuel rarity or exhaustion within the next half century.

Added to recent explosions in public concern over environmental issues, principally global warming, international protocols to limit carbon emissions, as well as public pressure to reduce carbon footprints has lead to planned developments of carbon trading and the like. Therefore, developing renewable resources and renewable energy is an important issue at many levels throughout many countries.

Electricity as a power source is integrated within most humans daily lives and the demand is increasing. Electricity is clean and beneficial in cities as particulate emissions and pollutants may be emitted outside. Thereby the city environments will be cleaner.

Currently, nuclear power is being billed as a replacement for fossil fuels however, nuclear power generation is still blighted by international disasters including Chernobyl, transport storage and disposal of nuclear waste is a big, expensive problem further compounded by decommissioning old reactors and environmental protection issues, mean electricity generated using nuclear reactors is relatively expensive. Furthermore, in countries susceptible to possible terrorism, natural disasters including typhoons, hurricanes tsunamis and especially earthquakes, widespread nuclear use would raise risks of a meltdown effecting large numbers of people.

However, current renewable energy sources such as solar, wind, wave and the like are very either expensive to build, or generate electricity inconsistently and cannot compete with fossil fuels on cost.

Therefore, the present invention provides a domestic gaseous coolant solar thermal collector generation system to use renewable sources to effectively generate electricity whilst fulfilling environmental protection issues.

### SUMMARY OF THE INVENTION

An objective of the present invention is to provide a steam solar thermal collector generation system using solar power as a heating source to convert coolant to gaseous coolant. Therefore, the steam power generator effectively provides a cycle electricity with less external electric power source to generate steam gaseous coolant as a rotating power resource. The present invention is easily built on a roof of a building.

The gaseous coolant solar thermal collector generation system has a liquid unit, a solar vaporizer, a turbine generator, a cooling and condensing unit, and a main control unit. The solar vaporizer heats a liquid from the liquid unit and converts the liquid to steam as a rotating power resource. As such result, the turbine generator is driven and then generates an electric power source. The steam passing through the turbine generator is re-converted to the liquid through the cooling and condensing unit, so the liquid unit from the cooling and condensing unit is recycled by the liquid unit. Therefore, the gaseous coolant solar thermal collector generation system utilizes the solar power to heat the coolant and further drive the steam generator, so the stream solar thermal collector generation system effectively utilizes the nature resource to generate the electric power source.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a gaseous coolant solar thermal collector generation system in accordance with the present invention; and

FIG. 2 is a perspective view of a solar vaporizer of the gaseous coolant solar thermal collector generation system in accordance with the present invention.

### DETAILED DESCRIPTION OF THE PREFERRED EMBODIMENT

As defined herein, a liquid, for example a coolant with a boiling point between around 30-60 degrees centigrade, that is vaporized above the boiling point and condensed below the boiling point.

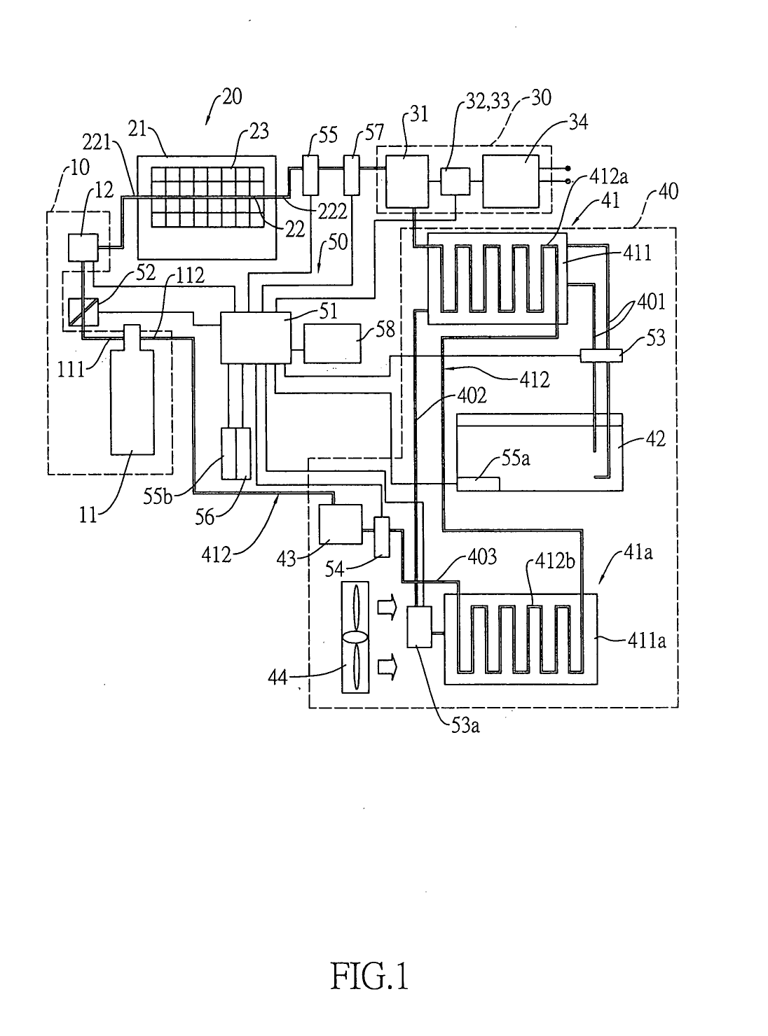

With reference to FIG. 1, a preferred embodiment of a solar thermal collector generation system is mounted on a roof of a building and has a liquid unit (10), at least one solar vaporizer (20), a turbine generator (30), a cooling and condensing unit (40), and a main control unit (50).

The liquid unit (10) has a liquid tank (11) and an optional nebulizer (12). The liquid tank (11) is filled with the liquid, such as the liquid coolant, and has a liquid inlet (112) and a liquid outlet (111). The liquid outlet (111) of the liquid tank (11) is connected to the nebulizer (12). When the liquid tank (11) outputs the coolant to the nebulizer (12), the nebulizer (12) nebulizes the coolant.

The solar vaporizer (20) may be mounted on the roof or other place under the sun and is connected to the liquid outlet (111) of the liquid tank (11) and may be connected to the nebulizer (12) of the liquid unit (10) to obtain the liquid coolant. After the liquid coolant is obtained, the solar vaporizer (20) heats the coolant into gaseous coolant (steam) at high pressure.

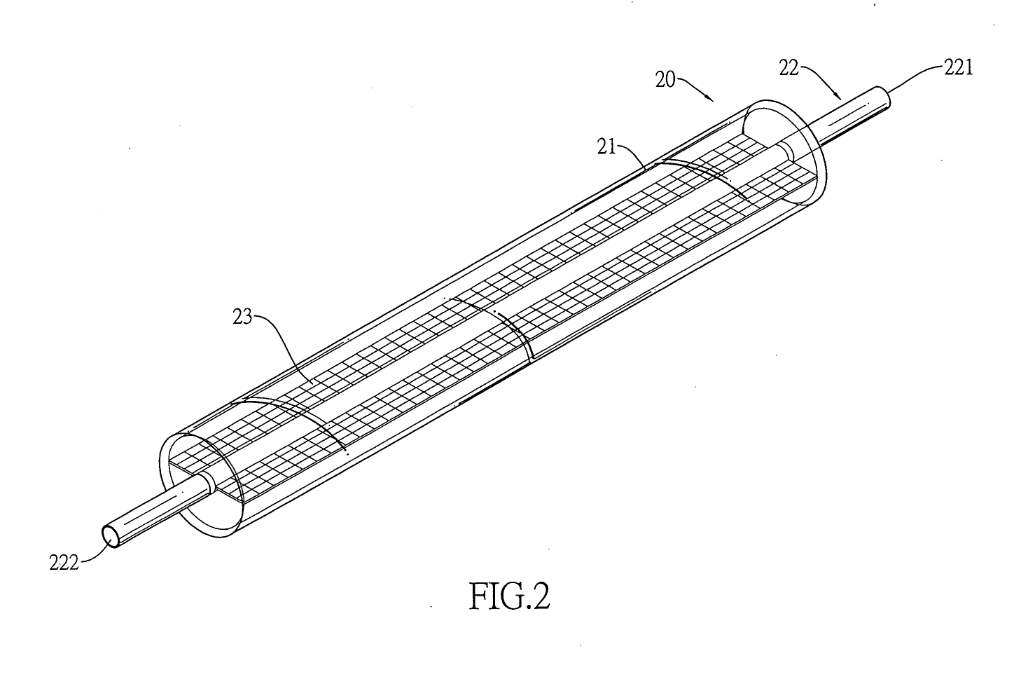

With further reference to FIG. 2, a preferred embodiment of the solar vaporizer (20) has an optional vacuum tube (21), a metal pipe (22) and a solar thermal heater (23). The vacuum tube (21) is glass to allow passage of solar radiation and minimize thermal emission. The metal pipe (22) is mounted axially in the vacuum tube (21) and has a gas output (221) and a liquid input (222). The liquid input (222) is connected to the liquid outlet (111) of the coolant supply unit (10) and may be connected to the nebulizer (12). The metal pipe (22) is mounted in the vacuum tube (21). The solar thermal heater (23) being inside the vacuum tube (21) and adjacent to outside the metal pipe (22) to increase a surface area of the metal pipe (22) absorbing solar radiation. Therefore, the coolant enters the metal pipe (22) and absorbs solar energy from the metal pipe (22) and is raised in temperature above the boiling point of the coolant to become the gaseous coolant at high pressure.

The turbine generator (30) is connected to the gas output (222) of the metal pipe (22) of the solar vaporizer (20) to obtain the gaseous coolant used to turn the turbine generator (30) for generating electricity and has an exhaust. The turbine generator (30) comprises a turbine (31), a tachometer (32), an automatic transmission (33) and a power generator (34). The turbine (31) is connected to the gas output (222) of the metal pipe (22) of the solar vaporizer (20) to obtain the gaseous coolant and has a turbine shaft. Therefore, the gaseous coolant at high pressure forces the turbine shaft to rotate. The tachometer (32) is connected to and measures a rotational speed of the turbine shaft. The automatic transmission (33) is connected to the turbine shaft, comprises an output shaft and changes the rotational speed of the turbine shaft into a rotational speed of the output shaft. The power generator (34) is connected to the output shaft of the automatic transmission (33). Therefore, the power generator (34) is driven to rotate by the turbine (31) through the automatic transmission (33) and generates electricity consistently and stably.

The cooling and condensing unit (40) is connected to the exhaust of the turbine generator (30) to retrieve gaseous coolant passing through the turbine (31) and then converts the gaseous coolant passing through the turbine (31) into liquid coolant. The cooling and condensing unit (40) is connected to the liquid supply unit (10) to return the liquid coolant back to the liquid unit (10) so the liquid coolant from the cooling and condensing unit (40) is recycled and stored in the liquid supply unit (10). The cooling and condensing unit (40) has a cooling pipe (412), a first heat exchanger (41), a second heat exchanger (41a), an optional storage tank (42) and a condenser (43) and an optional fan (44).

The cooling pipe (412) is connected to the exhaust of the turbine and the coolant supply unit (10), allows heat to be removed from the gaseous coolant and may comprise a first and second segment (412a, 412b), the first and second segments (412a, 412b) may be coiled, accordion, curved or the like to raise surface area per unit volume of the cooling pipe (412).

The first heat exchanger (41) has a first water tank (411) mounted around the first segment (412a) of the cooling pipe (412). The first water tank (41) is filled with water, so the gaseous coolant is condensing.

The second heat exchanger (41a) may comprise a second water tank (411a) to further cool the coolant. The second water tank (41a) may communicate with the first water tank (41) through a water pipe (402), is filled with water, is mounted around the second segment (412b) of the coolant pipe (412).

The fan (44) mounted adjacent to the second segment of the coolant pipe (412) to implement an air cooling device.

The water storage tank (42) is filled with water and is connected to the first water tank (41) through a hot pipe and a cool pipe (401). A pump or thermosiphon is attached to the hot and cool pipes (401) to allow water inside the first water tank (411) and the storage tank (42) to be exchanged. Since hot water is less dense than cold water, cold water will sink relative to hot water. Therefore, the hot pipe is mounted near a top of the first water tank (41) and to remove hotter water and the cool pipe is mounted near a bottom of the water storage tank (42). Therefore, the storage tank (42) may supply hot water to the building.

The condenser (43) is mounted on the cooling pipe (412) between the second heat exchanger (41a) and the liquid unit (10) to obtain the liquid coolant from the second heat exchanger (41a). The condenser (43) compresses the liquid coolant then returns the liquid coolant back to the liquid tank (11) of the liquid unit (10). Therefore, the coolant of the present invention is recycled through the solar thermal collector generation system to provide electricity and hot water and may be built on the roofs of buildings easily.

The main control unit (50) comprises a processor (51), a first control valve (52), optional first water valves (53), an optional second water valve (53a), a second control valve (54), multiple thermal sensors (55, 55a), an optical sensor (56), an ambient thermometer (55b), a pressure sensor (57) and a battery (58).

The processor (51) and battery (58) are respectively and electronically connected to the control valves (52, 54), the water valves (53, 53a), the control valve (54), the thermal sensors (55, 55a, 55b), the optical sensor (56), ambient thermometer (55b) the pressure sensor (57), the tachometer (32) and the automatic transmission (33). The battery (58) is also electronically connected to the processor (51).

The first control valve (52) is connected to the liquid outlet (111) of the liquid tank (11), so the processor (51) controls a flow rate of the coolant from the liquid tank (11).

The first water valve (53) is mounted on the hot pipe and the cool pipe (401) and may comprise a pump and the second water valve (53a) is mounted on the water pipe (402) and may comprise a pump. Therefore, the processor (51) may control water flow between the tanks (411, 411a, 42).

The second control valve (54) is mounted between the cooling pipe (412) and the condenser (43), so the processor (51) controls a flow rate of the liquid coolant from the second heat exchanger (41a) to the liquid unit (10).

The thermal sensors (55, 55a) are respectively mounted adjacent to the gas output (222) of the metal pipe (22) of the solar vaporizer (20) and inside the storage tank (42) to measure and transmit temperatures of the coolant in the solar vaporizer (20) and water inside the storage tank (42) to the processor (51).

The optical sensor (56) measures and transmits an external light reading to the processor (51).

The ambient thermometer (55b) records and transmits an external temperature to the processor (51).

The pressure sensor (57) is attached to the gas output (222) of the metal pipe (22) of the solar vaporizer (20) to measure and transmit a pressure value to the processor (51).

The processor (51) obtains a rotational speed value of the turbine (31), temperature and the light values, and controls the automatic transmission (33) to adjust rotational speed of the output shaft of the automatic transmission (33) according to the rotational speed of the turbine shaft. Therefore, the power generator (34) generates electricity consistently.

The processor (51) determines when the light reading from the optical sensor (56) corresponds to enough solar energy falling on the solar vaporizer (20). Then, the processor (51) controls the first and second control valves (52, 54), the water valves (53, 53a) and the automatic transmission (33), using signals from the multiple thermal sensors (55, 55a), the ambient thermometer (55b), the air pressure sensor (57) and the tachometer (32). The processor (51) firstly controls the first control valve (52) to supply enough coolant from the liquid tank (11) to the solar vaporizer (20) to maximize absorption of solar heat and ensure vaporization. Once the processor (51) determines the temperature of the coolant and pressure value of the gas output (222) of the metal pipe (22) of the solar vaporizer (20) are greater than predetermined therefore, sufficient gaseous coolant is generated, the processor (51) opens the gas output (222) of the solar vaporizer (20). Thereby, causing the turbine (31) to rotate and drive the output shaft of the automatic transmission (33) to rotate. Moreover, the processor (51) controls the automatic transmission (33) to adjust the rotational speed of the output shaft of the automatic transmission (33) connected to the power generator (34) according to the pressure value from the pressure sensor (57) and rotational speed of the turbine shaft. Therefore, the power generator (34) generates electricity consistently during operation.

Thereafter the gaseous coolant enters the first heat exchanger (41) and heats the water, once the processor (51) uses the thermal sensor (55a) inside the storage tank (42) to determine when the water temperature of the storage tank (42) has increased to a predetermined temperature and closes the water value (53) to stop exchanging water between the first water tank (411) and storage tank (42), and then opens optional another water value on the second water pipe (402) to add water inside the first and second water tanks (411, 411a). People in the building use the hot water from the storage tank (42). The gaseous coolant passing through the turbine (31) is converted to original coolant by the first and second heat exchangers (41, 42) and the condenser (43) and then the coolant is re-stored inside of the liquid tank (11).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A steam solar thermal collector generator system, comprising:
a liquid unit storing and supply a liquid;
a solar vaporizer connected to the liquid unit to obtain the liquid and heating the liquid to become steam with high pressure;
a turbine generator connected to the solar vaporizer to obtain the steam used as a rotating power resource to generate electric power; and
a cooling and condensing unit connected to retrieve the steam passing through the turbine generator, converting the steam to the liquid and connected to the liquid unit to gas output the liquid into the liquid unit.

2. The steam solar thermal collector generation system as claimed in claim 1, wherein the liquid unit comprises:
a liquid tank having
an liquid inlet connected to the cooling and condensing unit; and
an liquid outlet connected to the solar vaporizer; and
a nebulizer connected between the liquid outlet and the solar vaporizer to nebulize the liquid.

3. The steam solar thermal collector generation system as claimed in claim 1, wherein the solar vaporizer comprises:
a vacuum tube;
a metal pipe passing through the vacuum tube and having an liquid input connected to the liquid unit; and
an gas output connected to the turbine generator; and
a solar thermal heater being inside the vacuum tube and mounted outside of the metal pipe.

4. The steam solar thermal collector generation system as claimed in claim 2, wherein the solar vaporizer comprises:
a vacuum tube;
a metal pipe passing through the vacuum tube and having
an liquid input connected to the liquid inlet of the liquid tank; and
an gas output connected to the turbine generator; and
a solar thermal heater being inside the vacuum tube and mounted outside of the metal pipe.

5. The steam solar thermal collector generation system as claimed in claim 1, wherein the turbine generator comprises:
a turbine connected to the solar vaporizer, driven to rotate by spurting steam from the solar vaporizer and having a shaft;
a tachometer mounted to the shaft of the turbine; and
a power generator has a rotating shaft connected to the shaft of the turbine through a automatic transmission.

6. The steam solar thermal collector generation system as claimed in claim 2, wherein the turbine generator comprises:
a turbine connected to the solar vaporizer, driven to rotate by spurting steam from the solar vaporizer and having a shaft;
a tachometer mounted to the shaft of the turbine; and
a power generator has a rotating shaft connected to the shaft of the turbine through a automatic transmission.

7. The steam solar thermal collector generation system as claimed in claim 3, wherein the turbine generator comprises:
a turbine connected to the gas output of the metal pipe of the solar vaporizer, driven to rotate by spurting steam from the solar vaporizer and having a shaft;
a tachometer mounted to the shaft of the turbine; and
a power generator has a rotating shaft connected to the shaft of the turbine through a automatic transmission.

8. The steam solar thermal collector generation system as claimed in one of claims 1, wherein the cooling and condensing unit comprises:
a cooling pipe having
a first segment connected to the turbine generator to obtain the steam passing the turbine generator; and
a second segment connected between the first segment and the liquid unit;
a first heat exchanger having a first water tank mounted around the first segment;
a second heat exchanger having a second water tank mounted around the second segment and communicating with the first water tank through a water pipe;
a condenser mounted on the cooling pipe between the second heat exchanger and the liquid unit; and
a storage tank communicated with the first water tank through a hot pipe and a cool pipe.

9. The steam solar thermal collector generation system as claimed in one of claims 2, wherein the cooling and condensing unit comprises:
a cooling pipe having
a first segment connected to the turbine generator to obtain the steam passing the turbine generator; and
a second segment connected between the first segment and the liquid unit;
a first heat exchanger having a first water tank mounted around the first segment;
a second heat exchanger having a second water tank mounted around the second segment and communicating with the first water tank through a water pipe;
a condenser mounted on the cooling pipe between the second heat exchanger and the liquid unit; and
a storage tank communicated with the first water tank through a hot pipe and a cool pipe.

10. The steam solar thermal collector generation system as claimed in one of claims 3, wherein the cooling and condensing unit comprises:
a cooling pipe having
a first segment connected to the turbine generator to obtain the steam passing the turbine generator; and
a second segment connected between the first segment and the liquid unit;
a first heat exchanger having a first water tank mounted around the first segment;
a second heat exchanger having a second water tank mounted around the second segment and communicating with the first water tank through a water pipe;
a condenser mounted on the cooling pipe between the second heat exchanger and the liquid unit; and
a storage tank communicated with the first water tank through a hot pipe and a cool pipe.

11. The steam solar thermal collector generation system as claimed in one of claims 4, wherein the cooling and condensing unit comprises:
a cooling pipe having
a first segment connected to the turbine generator to obtain the steam passing the turbine generator; and
a second segment connected between the first segment and the liquid unit;
a first heat exchanger having a first water tank mounted around the first segment;
a second heat exchanger having a second water tank mounted around the second segment and communicating with the first water tank through a water pipe;
a condenser mounted on the cooling pipe between the second heat exchanger and the liquid unit; and
a storage tank communicated with the first water tank through a hot pipe and a cool pipe.

12. The steam solar thermal collector generation system as claimed in one of claims 5, wherein the cooling and condensing unit comprises:
a cooling pipe having
a first segment connected to the turbine generator to obtain the steam passing the turbine generator; and
a second segment connected between the first segment and the liquid unit;
a first heat exchanger having a first water tank mounted around the first segment;
a second heat exchanger having a second water tank mounted around the second segment and communicating with the first water tank through a water pipe;
a condenser mounted on the cooling pipe between the second heat exchanger and the liquid unit; and
a storage tank communicated with the first water tank through a hot pipe and a cool pipe.

13. The steam solar thermal collector generation system as claimed in one of claims 6, wherein the cooling and condensing unit comprises:
a cooling pipe having
a first segment connected to the turbine generator to obtain the steam passing the turbine generator; and
a second segment connected between the first segment and the liquid unit;
a first heat exchanger having a first water tank mounted around the first segment;
a second heat exchanger having a second water tank mounted around the second segment and communicating with the first water tank through a water pipe;
a condenser mounted on the cooling pipe between the second heat exchanger and the liquid unit; and
a storage tank communicated with the first water tank through a hot pipe and a cool pipe.

14. The steam solar thermal collector generation system as claimed in one of claims 7, wherein the cooling and condensing unit comprises:
a cooling pipe having:
a first segment connected to the turbine generator to obtain the steam passing the turbine generator; and
a second segment connected between the first segment and the liquid unit;
a first heat exchanger having a first water tank mounted around the first segment;
a second heat exchanger having a second water tank mounted around the second segment and communicating with the first water tank through a water pipe;
a condenser mounted to the cooling pipe between the second heat exchanger and the liquid inlet of the liquid tank of the liquid unit; and
a storage tank communicated with the first water tank through a hot pipe and a cool pipe.

15. The steam solar thermal collector generation system as claimed in claim 14, further comprising:
a processor electronically connected to tachometer and the automatic transmission;
a first control valve connected to the liquid outlet of the liquid tank and electrically connected to the processor;
a first water valve mounted on the hot pipe and the cool pipe;
a second water valve mounted on the water pipe;
a second control valve mounted between the second cooling pipe and the condenser and electronically connected to the processor;
multiple thermal sensors respectively mounted adjacent to the gas output of the metal pipe of the solar vaporizer, and inside the storage tank to measure and transmit temperatures of the liquid in the solar vaporizer and water inside the storage tank to the processor;
an optical sensor electronically connected to the processor;
an ambient thermometer electronically connected to the processor; and
an pressure sensor attached to the gas output of the metal pipe of the solar vaporizer and electronically connected to the processor.

16. The steam solar thermal collector generation system as claimed in claim 15, further comprising a fan attached to the second heat exchanger.

17. The steam solar thermal collector generation system as claimed in claim 3, the vacuum tube is made of glass.

18. The steam solar thermal collector generation system as claimed in claim 4, the vacuum tube is made of glass.

19. The steam soar thermal collector generation system as claimed in claim 1, wherein the liquid is a coolant and the steam output from the solar vaporizer is a gaseous coolant.
